(19) United States
(12) Patent Application Publication
(10) Pub. No.: US 2010/0284736 A1
(43) Pub. Date: Nov. 11, 2010

(54) COUPLING ELEMENT FOR TRANSMITTING TORQUE AND DRIVE UNIT COMPRISING SAID COUPLING ELEMENT

(75) Inventors: Roland Langer, Schwanfeld (DE); Sebastian Lorenz, Rothenkirchen (DE); Peter Niebling, Bad Kissingen (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/741,968

(22) PCT Filed: Nov. 4, 2008
(86) PCT No.: PCT/DE08/01814

§ 371 Date: Jul. 21, 2010

(30) Foreign Application Priority Data
Nov. 10, 2007 (DE) 10 2007 053 728.1

(51) Int. Cl. F16D 1/02

(52) U.S. Cl. 403/364

(57) ABSTRACT

For torque transmission, for example between an articulated shaft and a hub to a drive motor vehicle wheel, it is necessary to non-rotatably couple the articulated shaft or a corresponding intermediate piece and the hub to each other. For this purpose, a coupling element, particularly a hub element, is proposed for transmitting torque about a rotational axis that is oriented in an axial direction and has a serration, which extends in the peripheral direction about the rotational axis. The serration has a plurality of teeth. Each tooth is configured as a triangle in a longitudinal section along the peripheral direction such that two tooth faces are formed, which end in a tooth head region, and at least one of the tooth faces is configured convexly in the longitudinal section with respect to an imaginary straight reference tooth face.

### FIELD OF THE INVENTION

The invention relates to a coupling element for transmitting torques about an axis of rotation oriented in an axial direction, with a spur toothing which has a plurality of teeth, each tooth being of triangle-like design in a longitudinal section along the direction of revolution, so as to form two flanks which end in a tooth tip region. The invention relates, further, to a drive unit comprising said coupling element.

For torque transmission, for example, between a cardan shaft and a hub on a driven motor vehicle wheel, it is necessary to couple the cardan shaft or a corresponding intermediate piece and the hub to one another rotatably fixedly.

The rotatably fixed coupling is usually implemented by means of a radial toothing, that is to say a toothing in which the teeth are directed radially inward or outward, a radial toothing of the cardan shaft engaging into a radial countertoothing of the hub. During the assembly, the cardan shaft and hub are pushed one into the other and braced axially. However, in the case of the radial toothing for torque transmission, it is known that problems regarding the function or regarding comfort may arise during operation between the hub or wheel flange and the cardan shaft on account of the toothing backlash.

Another concept for the toothing of a cardan shaft or intermediate piece and a hub is disclosed, in the form of a spur toothing for a drivable wheel hub, in the publication DE 10 2005 009 939 A1 which probably constitutes the nearest prior art. Instead of a radial toothing, this publication proposes a spur toothing which, on the one hand, is formed into the wheel hub and, on the other hand, is introduced as a countertoothing into the cardan shaft. During assembly, the cardan shaft and wheel hub are braced with one another in the axial direction, so as to form a positive/nonpositive connection between these components.

The object of the present invention is to propose a coupling element for transmitting torques, having a spur toothing, which coupling element is distinguished by benefits in functional terms.

This object is achieved by means of a coupling element having the features of claim 1 and a drive unit having the features of claim 11. Preferred or advantageous embodiments of the invention may be gathered from the subclaims, the following description and the accompanying figures.

According to the invention, a coupling element for transmitting torques about an axis of rotation oriented in an axial direction is proposed. The coupling element may be designed as any intermediate or final element in a kinematic chain, and preferably the coupling element is implemented as a hub, in particular wheel hub, and/or as a fixed joint or loose joint.

The coupling element has a spur toothing which can be fastened in any desired way to the coupling element, preferably is formed onto or into the coupling element. The spur toothing is arranged in the direction of revolution about the axis of rotation, there preferably being provision whereby said spur toothing extends, in a radial plane perpendicular to the axis of rotation, in a concentric arrangement with respect to the axis of rotation. In modified embodiments, however, the spur toothing may also form a surface which is arranged at an oblique angle with respect to the axis of rotation.

The spur toothing has a plurality of teeth, each tooth being of triangle-like design in a longitudinal section, in particular in a flat projection along the direction of revolution, the sides of the triangle being formed by the tooth flanks which meet one another in a tooth tip region. The meaning of the term “triangle-like” in the present context is merely that two flanks of a tooth meet one another in a tooth tip region.

According to the invention, it is proposed that at least one, preferably both of the tooth flanks is or are of crowned design in said longitudinal section in the direction of revolution, as compared with an imaginary straight reference tooth surface.

This inventive design of the coupling element results in the effect that, after an axial bracing of the coupling element with a counter element having a countertoothing, a uniform load bearing of the tooth flanks, particularly with a homogenized pressure distribution in the surface extent of the tooth flanks, is achieved. In particular, this effect is implemented in comparison with a spur toothing having straight tooth flanks. In a spur toothing having straight tooth flanks, contact between the toothing and countertoothing is over determined in geometric terms on account of the multiplicity of possible contact points between the toothing and the countertoothing. The, in particular, slight crowning of the tooth flanks, which is proposed according to the invention, makes it possible to place the toothing on the countertoothing in such a way that contact points in the crowned region which project to a greater extent are lowered as a result of plastic or elastic deformation, so that the toothing comes into place uniformly on the countertoothing via a multiplicity of contact points. The contours of the toothings are thus adapted to one another as a result of the placing operation.

In a preferred embodiment, in said longitudinal section, the crowning is formed symmetrically, or approximately symmetrically, so that a center point of the crowning is located in a central region on the tooth flank. Particularly preferably, the tooth flank is designed in its radial extent in such a way that the center points of the crowning are strung up in a line defining a straight line which runs through the axis of rotation of the coupling element. In particular, the center points lie on a radial plane perpendicular to the axis of rotation.

In a preferred embodiment of the invention, particularly in the form of a wheel bearing unit, in said longitudinal section the actual tooth flank deviates with respect to the straight reference tooth flank by the amount of a maximum deviation which is at least 0.005 mm or 0.01 mm, preferably at least 0.1 mm and at most 0.9 mm, preferably at most 0.5 mm and, in particular, at most 0.3 mm. In this dimensioning for a conventional coupling element having a diameter in the region of a spur toothing of approximately 30 to 100 mm, the additional material is sufficient to achieve the desired effect of homogenized load distribution.

If the geometry of the teeth and the spur toothing is described in a somewhat more abstract way, each tooth circumscribes a triangle, the triangle sides of adjacent teeth or triangles intersecting one another in an imaginary prolongation, so that the triangles of adjacent teeth are lined up uninterruptedly next to one another. All the triangles or teeth are preferably of identical design.

In this abstract illustration, then, the above-defined maximum deviation of the tooth flank with respect to the straight reference tooth flank can optionally be described as a function of the triangle height or triangle width. The triangle height is in this case relative to the tooth height, and the triangle width describes the tooth width in the direction of revolution.

Preferably, according to a more general definition, the coupling element is configured in such a way that the ratio between the maximum deviation of the tooth flank in the longitudinal section with respect to the reference tooth flank and the triangle height is at least 0.005:5, preferably at least 0.1:5, in particular at least 0.3:5, and/or at most 0.9:5, preferably at most 0.5:5 and, in particular at most 0.3:5.

Alternatively or additionally to this, the ratio between the maximum deviation of the tooth flank in the longitudinal section with respect to the reference tooth flank and the triangle width may be at least 0.005:5, preferably at least 0.1:5, in particular at least 0.3:5, and/or at most 0.9:5, preferably at most 0.5:5 and, in particular, at most 0.3:5.

In a preferred development of the invention, a tooth is formed so that the tooth tip region is of rounded design, specifically preferably with a radius of between 0.1 mm and 3 mm. Additionally, there is provision whereby the rounded tip region extends in the radial direction over at least 20% of the triangle height and/or of the tooth length. This rounding allows a simplified assembly of the spur toothing with a countertoothing, since the respectively corresponding teeth are not jamming during assembly. The tooth length in the radial direction amounts, for example, to approximately 10 mm. A typical tooth opening angle preferably amounts to between 40° and 60°, in particular to 55°. The tooth gaps between the teeth are preferably likewise of rounded design, said tooth gaps being dimensioned in such a way that, in an assembled state, a freed interspace remains between the tooth tip region of the countertoothing and the bottom of the tooth gaps of the spur toothing.

In a preferred embodiment, the coupling element is designed as a hub element which is provided, for example in the case of driven motor vehicle wheels, for transmitting the drive torque to the wheels of the motor vehicle.

In a particularly preferred development of the invention, the hub element is designed as a one-piece or one-material element with a formed-on wheel flange and/or with a formed-on brake disk or brake disk flange as an integrated component. Optionally or additionally, the hub element or the integrated component is implemented as an inner ring, on which the rolling bodies of a wheel bearing roll, and/or has a carrier region for an inner ring of this type. In particular, the coupling element is designed as a wheel bearing unit.

A further subject of the invention relates to a drive unit having a hub element as claimed in one of the preceding claims or as has just been described, and with a cardan shaft or an intermediate element coupled to the cardan shaft (referred to below in summary as a cardan shaft), the cardan shaft having a spur countertoothing which, in the assembled state, engages into the spur toothing of the hub element for the rotationally fixed connection. The engaging end portion of the cardan shaft is preferably designed as a joint bell.

What is achieved by the design according to the invention of the spur toothing is that, as already described above, the spur toothing and spur countertoothing engage one in the other with a homogeneous pressure distribution.

In principle, the spur countertoothing may be designed in a similar way to the spur toothing with a crowned flank contour. In a cost-effective and therefore preferred embodiment, however, the spur countertoothing has straight tooth flanks, the improved pressure distribution being achieved solely by means of the crowning of the spur toothing of the hub element. In yet other embodiments, in particular, but not exclusively with regard to the first subject of the invention, the crowned flank contour is arranged on the countertoothing and the straight flank contour on the spur toothing of a coupling element or of the drive unit according to the further subject of the invention.

Further features, advantages and effects of the invention may be gathered from the following description of a preferred exemplary embodiment. In the drawing:

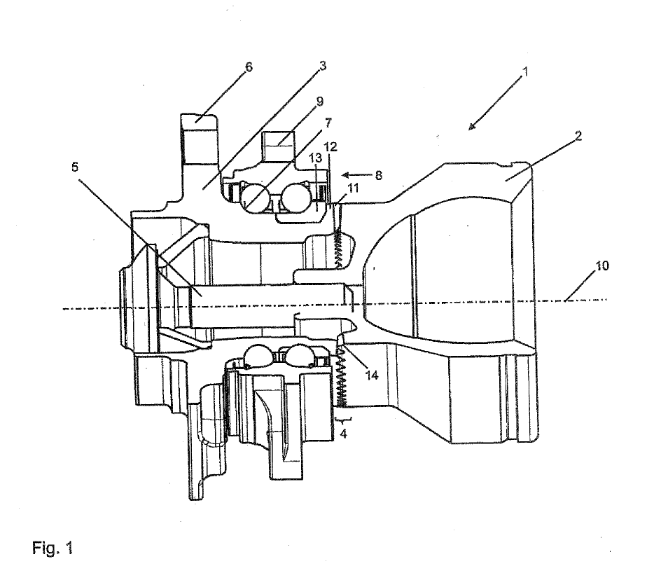

FIG. 1 shows a schematic sectional illustration of a drive unit as an exemplary embodiment of the invention; and

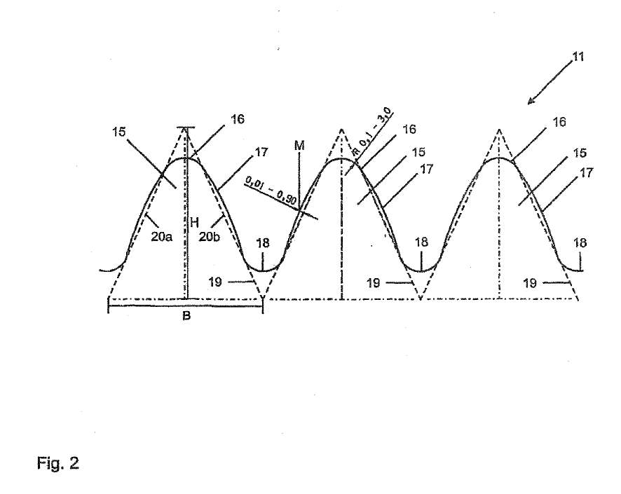

FIG. 2 shows a schematic longitudinal section along the direction of revolution of a spur toothing of the drive unit in FIG. 1.

FIG. 1 shows a schematic sectional illustration of a drive unit 1 as an exemplary embodiment of the invention, which is used, for example, for driving a wheel on a motor vehicle.

The drive unit has a joint bell 2 and a hub unit 3 which are connected to one another rotatably fixedly via an axial toothing 4, in that the joint bell 2 and hub unit 3 are braced one in the other and with one another in the axial direction via a central screw 5 with a force of 60 kN to 200 kN, preferably of between 90 kN and 120 kN.

The hub unit 3 is designed as a one-piece highly integrated structural wheel bearing unit, the hub unit 3 comprising a flange 6, formed in one piece for a brake disk or a rim, and also an inner ring raceway 7 for a first ball row of wheel bearing 8.

The hub unit 3 and a joint bell 2 braced with one another as a subassembly are mounted rotatably about an axis of rotation 10 via the wheel bearing 8 relative to a flange 9 stationary with respect to the vehicle.

In the region of the axial toothing 4, the hub unit 3 has a spur toothing 11 which is introduced into the hub unit 3, for example, by means of a forming process or a stripping process, in particular a cutting process. More specifically, the spur toothing 11 is formed into a free end region of the hub unit 3, which is designed as a radially outwardly turned-up collar 12 or shoulder which extends in the radial direction. On that end face of the collar 12 which faces away from the spur toothing 11, a peripheral recess is introduced into the hub unit 3, an inner ring 13 for the second row of balls of the wheel bearing 8 being inserted into said recess. The collar 12 is thus supported in the axial direction on the hub unit 3 via the inserted inner ring 13.

The spur toothing 11 is in engagement with a counter toothing 14 which is formed into the joint bell 2, for example, via a forming process. The axial toothing 4 is arranged concentrically with respect to the axis of rotation 10 and runs in a radial plane oriented perpendicularly with respect to the axis of rotation 10. The outside diameter of the axial toothing 4 amounts to about 30 mm to 100 mm.

FIG. 2 shows a detail of the flat projection of the spur toothing 11 in the direction of revolution about the axis of the rotation 10 (FIG. 1) in the radial outer region of the axial toothing 4.

The detailed illustration in FIG. 2 shows three teeth 15 of the spur toothing 11, the form of the teeth 15 being constant or essentially constant in the radial direction or alignment, with the dimension or size of the teeth 12 being designed to decrease in this direction.

Preferably, the spur toothing 11 is implemented as what is known as a Hirth toothing, the teeth of the spur toothing 11 being wedge-shaped in the ideal form in such a way that radially extending geometric lines of the spur toothing 11 coincide centrally at a common point on the axis of rotation 10 and the teeth 15 therefore extend on the axis of rotation 10 in the radial direction.

In a real form of the invention, a tooth 15 is formed by a rounded tip region 16 with radius a R=0.1 mm-3.0 mm, with flank regions 17 and with a likewise rounded gap region 18. In one implementation of the spur toothing 11, the tip region 16 and the gap region 18 are designed to be constant in the longitudinal section in the radial direction with respect to the axis of rotation 10, the flank region 17 decreasing in flank height in the radial direction toward the axis of rotation 10. In the radially outer region shown in FIG. 2, the tip region 16 occupies approximately 20% of the overall height H of one of the teeth 15. The rounding of the tip region 16 is shaped, in radial extent, over at least approximately 20% of the tooth length. The shaping either extends over the entire tooth length or over at most 60%, in particular at most 40% of the tooth length.

In FIG. 2, dashed lines depict triangles 19 which are adapted in each case to the teeth 15. The triangles 19 thereby define a tooth height H, a tooth width B and two reference tooth flanks 20a and 20b. The width B of one of the teeth 15 amounts to approximately 4 mm, and the height H amounts to approximately 3 mm. As can readily be gathered from FIG. 2, particularly in the illustration of the middle tooth 15, the flank region 17 is designed to be crowned with respect to the reference tooth flank 20a, the maximum difference, in the longitudinal section shown, between the reference tooth flank and flank region 17 being 0.005 mm to 0.90 mm. In particular, each of the flank regions 17 carries a crowning of this type. The center point M of the crowning is arranged approximately centrally with respect to the flank region 17, there being formed, in radial extent, a center point line which is arranged in a radial plane perpendicular to the axis of rotation 10 and/or intersects the axis of rotation 10.

During assembly of the hub unit 3 with the joint bell 2, the spur toothing 11 and countertoothing 14 first bear one against the other in an over defined manner, so that a multiplicity of contact points or contact lines between the spur toothing 11 and countertoothing 14 are formed.

When the hub unit 3 is being braced axially with the joint bell 2, the spur toothing 11 and countertoothing 14 are first pressed together in such a way that radially directed contact lines occur between the toothings. Yet also these contact lines are initially over defined, and therefore not every tooth 15 of the spur toothing 11 forms such a contact line with every tooth of the countertoothing 14.

By the axial force being increased and as a result of a partially plastic and partially elastic deformation, the contact lines which have already occurred are converted into contact surfaces, and at the same time contact lines or contact surfaces are formed between hitherto non-contacting teeth of the spur toothing 11 and countertoothing 14.

Ideally, after an operation to put the spur toothing 11 and countertoothing 14 in place, each flank 17 of the teeth 15 of the spur toothing 11 is in contact with the corresponding counter flank of the countertoothing 14.

Consequently, the hub unit 3 and joint bell 2, as a result of subassembly, transmit the torques about the axis of rotation 10 via a multiplicity of contact points, contact lines and contact surfaces, so that a local overloading of the hub unit 3 or joint bell 2 in the region of the axial toothing 4 and therefore premature wear in the region are prevented.

### LIST OF REFERENCE SYMBOLS

1 Drive unit
2 Joint bell
3 Hub unit
4 Axial toothing
5 Central screw
6 Wheel flange
7 Inner ring raceway
8 Wheel bearing
9 Flange
10 Axis of rotation
11 Spur toothing
12 Collar
13 Inner ring
14 Countertoothing
15 Tooth
16 Rounded tip region
17 Flange region
18 Gap region
19 Triangle
20a, 20b Reference tooth flank

1. A coupling element for transmitting torques about an axis of rotation oriented in an axial direction, comprising:
a spur toothing which extends in the a direction of revolution about the axis of rotation,
the spur toothing having a plurality of teeth, each tooth being of triangle-like design in a longitudinal section along the direction of revolution, so as to form two tooth flanks which end in a tooth tip region,
wherein at least one of the tooth flanks is of crowned design in the longitudinal section with respect to an imaginary straight reference tooth flank.

2. The coupling element of claim 1, wherein the crowning is designed so that, after an axial bracing of the spur toothing with a countertoothing, a uniform load bearing of the tooth flanks and/or a more uniform load bearing with respect to the spur toothing having the tooth reference flank are/is achieved.

3. The coupling element of claim 2, wherein, in the longitudinal section, a center point of the crowning is arranged centrally and/or in the a middle on the tooth flank.

4. The coupling element of claim 1, wherein the tooth flank has, in the longitudinal section, with respect to the reference tooth flank, a maximum deviation of at least 0.005 mm, preferably of at least 0.1 mm, in particular of at least 0.3 mm, and/or of at most 0.9 mm, preferably of at most 0.5 mm, in particular of at most 0.3 mm.

5. The coupling element of claim 1, wherein, in the longitudinal section, each reference tooth flank is of a tooth form a triangle in an imaginary prolongation, triangles of adjacent teeth being lined up uninterruptedly next to one another.

6. The coupling element of claim 5, wherein a ratio between a maximum deviation of the tooth flank in the longitudinal section with respect to the reference tooth flank and a triangle width is at least 0.005:5, preferably at least 0.1:5, in particular at least 0.3:5, and/or at most 0.9:5, preferably at most 0.5:5 and, in particular, at most 0.3:5.

7. The coupling element of claim 1, wherein a transition between a tip circle diameter and the tooth flank is rounded.

8. The coupling element of claim 6, wherein a rounded tip region extends over at least 20% of a triangle height and/or of the tooth length.

9. The coupling element of claim 1, wherein the coupling element is a hub element.

10. The coupling element of claim 9, wherein the hub element is designed as a one-piece element with a wheel flange and/or with an inner ring raceway and, as a wheel bearing unit.

11. A drive unit, comprising:
a hub element as claimed in claim 10, and
a cardan shaft or an intermediate element connected to the cardan shaft,
wherein the cardan shaft has a spur countertoothing which, in an assembled state, engages into the spur toothing of the hub element for a rotationally fixed connection.

12. The drive unit of claim 11, wherein the spur countertoothing has straight tooth flanks.

13. The coupling clement of claim 7, wherein the transition between the tip circle diameter and the tooth flank has a radius of 0.1 to 3 mm.
